(19) United States
(12) Patent Application Publication
(10) Pub. No.: US 2026/0289921 A1
(43) Pub. Date: Sep. 24, 2026

(54) EXTENDED REALITY ENVIRONMENT

(71) Applicant: Sony Interactive Entertainment Europe Limited, London (GB)

(72) Inventors: David Erwan Damien Uberti, London (GB); Richard Thomas Downey, London (GB); Martin Selby George, London (GB); Steven Osman, London (GB); Christopher William Henderson, London (GB)

(21) Appl. No.: 19/555,338

(22) Filed: Mar. 3, 2026

(30) Foreign Application Priority Data
Mar. 24, 2025 (GB) 2504296.1

(51) Int. Cl. G06T 19/00; G06T 15/50; G06T 19/20; G06V 20/20

(52) U.S. Cl. CPC G06T 19/006; G06T 15/506; G06T 19/20; G06V 20/20; G06T 2207/20081; G06T 2219/2004

(57) ABSTRACT

There is provided method of providing an extended reality environment, the method comprising obtaining user environment data relating to the physical environment of a user electronic device, processing the user environment data to identify at least one attribute of the physical environment of a user electronic device, rendering a mixed reality environment, wherein at least one element of the mixed reality environment is adjusted based on the at least one attribute, and providing the rendered mixed environment to the user electronic device.

### CROSS-REFERENCE TO RELATED APPLICATIONS

This application claims priority to United Kingdom Application No. 2504296.1, filed on Mar. 24, 2025, the contents of which are incorporated herein by reference.

### FIELD

The present specification relates to a method and system. The present specification relates particularly, but not exclusively, to a computer-implemented method and system. The present specification relates particularly, but not exclusively, to the modification of an extended reality environment based on data obtained from a user electronic device within a physical environment.

### BACKGROUND

Extended reality applications, encompassing virtual reality (VR), augmented reality (AR), and mixed reality (MR), are experiencing a surge in popularity across diverse industries and consumer markets. This growth can be attributed to advancements in technology, including more affordable hardware, improved software capabilities, and increased accessibility of development tools. Extended reality applications offer immersive and interactive experiences that transcend traditional boundaries, enabling users to explore virtual environments, interact with digital objects overlaid on the real world, or engage in collaborative experiences regardless of physical distance.

Developers for extended reality applications are constantly looking to integrate extended reality with other emerging technologies like artificial intelligence to transform the way we interact with digital content and the world around us and to provide the best possible user experience.

Aspects and embodiments were conceived with the foregoing in mind.

### SUMMARY

Aspects of the present disclosure are set out in the accompanying independent and dependent claims. Combinations of features from the dependent claims may be combined with features of the independent claims as appropriate and not merely as explicitly set out in the claims.

Aspects may relate to extended reality environments. An extended reality environment may be described as an environment provided using an application or other piece of software, such as, for example, a computer game, for user interaction within the environment. An extended reality environment may also be described as an augmented reality environment.

According to a first aspect of the present disclosure, there is provided a method of providing an extended reality environment. The method may be implemented by a processing resource such as, for example, a computing device. The processing resource may comprise any entity which can provide processing capacity. The processing resource may be software, hardware or cloud implemented.

The method may comprise receiving obtaining user environment data from at least one user electronic device. The user electronic device may be any computing device which can record data relating to the physical environment of the user electronic device and/or the user’s interaction with that environment. The physical environment of the user electronic device may be understood to be the real-world environment which surrounds the user electronic device. Obtaining user environment data may comprise receiving data related to any aspect of the real-world environment. This may include data relating to the presence, movement, orientation or alteration of a physical object which is present in the real-world environment. This may, additionally or alternatively, include data relating to an environmental measurement of the real—world environment such as, for example, a change in lighting or a change in temperature of the real-world environment.

The method may comprise initialising an extended reality environment. Initialising an extended reality environment may comprise initialising and allocating the hardware and software resources needed to implement the extended reality environment.

The method may further comprise processing the user environment data to identify at least one attribute of the physical environment of the user electronic device. The obtained attribute may comprise object data and/or lighting data. The object data may be indicative of static and/or dynamic objects within the physical environment of the user electronic device, and the lighting data may comprise information relating to the lighting conditions within the physical environment of the user electronic device. The object data may be indicative of movement, alteration, addition or orientation of the attribute of the physical environment.

The method may further comprise rendering an extended reality environment and providing the rendered extended reality environment to the at least one user electronic device. The extended reality environment may comprise a plurality of elements, the elements being virtual and/or physical. At least one element of the plurality of elements may be adjusted based on the at least one attribute.

Aspects in accordance with the first aspect enable an extended reality environment to be rendered based on the received data related to the physical environment surrounding a user electronic device. This means that the user experience is significantly improved, and a greater level of immersion is provided for the user. Virtual objects can be rendered with respect to physical objects within the user’s physical environment whilst also taking into account dynamic objects. Furthermore, lighting conditions of the physical environment and their effect on the virtual objects in the extended reality environment are also taken into consideration, thus giving the user the impression that the virtual objects are really in the physical environment with the user.

In addition to the above, resources can be allocated to where they are most likely to be required, i.e. more processing resources allocated to high demand areas of an extended reality environment and less resources allocated to low demand areas of an extended reality environment.

Optionally, the computing device may be part of the user electronic device.

Optionally, the computing device may be separate to the user electronic device. A user electronic device may be used to capture the user environment data and send the captured user environment data to a computing device which is a separate device to the user electronic device which may be within the same or in a different physical environment as the user electronic device.

Optionally, a plurality of user electronic devices may be used. The user environment data may be obtained using a first of the plurality of user electronic devices, processed at the computing device, and then a rendered extended reality environment may be sent to the plurality of user electronic devices which may or may not be within the same physical environment.

By allowing for a plurality of arrangements with the placement of the computing device and the user electronic device a more versatile extended reality system is provided. The extended reality system would therefore not be limited to being used by user’s who have specialist hardware such as an extended reality headset. For example, by having a server act as the computing device, a user who only has a mobile phone would still be able to enjoy some or all of the extended reality system as the mobile phone would be able to capture user environment data within the user’s physical environment and send the data to the server for processing before receiving a rendered extended reality environment.

Optionally, rendering the extended reality environment comprises rendering a virtual object in a virtual location relative to a physical location of the static and/or dynamic objects within the physical environment of the user electronic device. The object data may comprise information such as the location, orientation and dimensions of an object, thus allowing the virtual object(s) to be rendered in such a way that they do not coincide with the physical object(s) in the physical environment in the sense that they appear to be in the same location as the physical object. This in turn provides a more immersive and realistic user experience.

Optionally, the physical location of the dynamic objects within the physical environment of the user electronic device is continuously tracked. The object data may comprise information such as the motion status of the object. By monitoring the motion of the physical dynamic objects in the physical environment, the extended reality environment can be adjusted to accommodate such movement and prevent the dynamic objects from clashing with the rendered virtual objects as they move around the physical environment. Optionally, any object rendered in the extended environment which corresponds to the physical dynamic object may be synchronised with the physical dynamic object. Furthermore, the virtual objects may be rendered to interact with said dynamic physical objects to further enhance the immersion of the user.

Optionally, rendering the extended reality environment further comprises converting the static and/or dynamic objects into static and/or dynamic virtual objects. The object data may comprise information such as the identity of the object. By determining the identity of the physical objects, the extended reality environment may be rendered to replace physical objects with virtual objects to further enhance the immersive experience. The extended reality environment may be rendered based on user preferences. That is to say, the user may configure a user profile which is used to render the extended reality environment in accordance with set preferences. For example, some objects may be disregarded in accordance with the preferences. In another example, some objects may be rendered using specific colours, patterns and indicators which are specified in the preferences.

Optionally, converting the static and/or dynamic objects into static and/or dynamic virtual objects may comprise utilising a machine learning model (such as an artificial neural network) which is trained used a vast library of input data relating to labelled physical objects to identify what the physical object is. The method may further comprise the machine learning model matching the identified object with a corresponding virtual object in a virtual object database. By using an artificial neural network (ANN) to determine corresponding virtual objects, a more accurate representation of the physical object by way of a virtual object may be established. Furthermore, the processing required to search through a vast catalogue of virtual objects is also reduced. The processing resource may be configured to segment one or more static and/or dynamic objects from received data to separate objects from the received data. Data which is extraneous to the static and/or dynamic object which has been segmented may be discarded.

ANNs are otherwise known as connectionist systems which are computing systems which are vaguely inspired by biological neural networks. Such systems “learn” tasks by considering examples, generally without task-specific programming. They do this without any prior knowledge about the task or tasks, and instead, they evolve their own set of relevant characteristics from the learning/training material that they process. ANNs are considered nonlinear statistical data modelling tools where the complex relationship between inputs and outputs are modelled, or patterns are found. ANN may be hardware (where neurons are represented by physical components) or software-based (computer models) and can use a variety of topologies and learning algorithms. It will be appreciated that other feedforward models (e.g., a trained regression tree model) may also be applicable for predicting/determining resource allocation based on received data related to the physical environment.

Alternatively or additionally, convolutional neural networks (CNNs) can be deployed to determine the identify of objects inside the physical environment or virtual environment.

CNNs can also be hardware or software based and can also use a variety of topologies and learning algorithms. A CNN usually comprises at least one convolutional layer where a feature map is generated by the application of a kernel matrix to an input image. This is followed by at least one pooling layer and a fully connected layer, which deploys a multilayer perceptron which comprises at least an input layer, at least one hidden layer and an output layer. The at least one hidden layer applies weights to the output of the pooling layer to determine an output prediction.

Either of the ANN or CNN may be trained using images of physical objects which may be identified or need to be identified in accordance with the method. The training may be implemented using feedforward and backpropagation techniques.

Large language models or deep neural networks may also be deployed to identify objects and to generate and render the extended reality environment.

Optionally, the lighting data may comprise an ambient light level indicative of the brightness of the physical environment and rendering the extended reality environment may comprise determining that the ambient light level is higher or lower than a pre-defined threshold and adjusting a virtual environment light level. Adjustments can be made to the image quality of the extended reality environment based on the brightness of the physical environment, thus allowing for the extended reality to consistently be output in the optimal picture quality regardless of the lighting conditions of physical environment.

Optionally, the lighting data may comprise light source data indicative of the sources of light within the physical environment and rendering the extended reality environment may comprise adjusting a virtual object lighting based on the determined sources of light. By identifying the light sources in the physical environment, the level of immersion and realism can be further enhanced as the virtual objects may be rendered with realistic lighting effects based on the physical light sources themselves. This includes shadows of the virtual objects and the illumination of the virtual object with respect to the light sources.

Optionally, the lighting data may comprise reflective surface data indicative of reflective surfaces within the physical environment and rendering the extended reality environment may comprise adjusting a virtual reflectivity level. Reflective surfaces may interfere with the rendering process as further processing is required to render reflections of virtual objects that are not physically in the physical environment. Mitigating the need to render reflections of virtual objects may reduce the processing requirements to render the extended reality environment as a whole.

According to a second aspect of the present disclosure, there is provided a user electronic device comprising a processor, and memory including executable instructions that, as a result of execution by the processor, cause the user electronic device to perform the computer-implemented method of any embodiment or example of the first aspect of the disclosure.

According to a third aspect of the present disclosure, there is provided non-transitory computer readable medium containing program instructions for causing a computer to perform the computer-implemented method of any example or embodiment of the second aspect of this disclosure.

### BRIEF DESCRIPTION OF THE DRAWINGS

Embodiments of this disclosure will be described hereinafter, by way of example only, with reference to the accompanying drawings in which like reference signs relate to like elements and in which:

FIG. 1 is a block diagram illustrating a user electronic device according to an embodiment of this disclosure;

FIG. 2 is a flowchart illustrating a method of providing an extended reality environment according to an embodiment of this disclosure;

FIG. 3 is an illustration of a physical environment comprising physical objects according to an embodiment of this disclosure;

FIG. 4 is an illustration of an extended reality environment which has been rendered based on object data identified from processing user environment data relating to the physical environment of FIG. 3 according to an embodiment of this disclosure;

FIG. 5 is a further illustration of an extended reality environment which has been rendered based on object data identified from processing user environment data relating to the physical environment of FIG. 3 according to an embodiment of this disclosure;

FIG. 6 is a flowchart illustrating a method of rendering a mixed reality environment based on an ambient light level according to an embodiment of this disclosure;

FIG. 7 is an illustration showing the method of FIG. 6 applied to a mixed reality environment according to an embodiment of this disclosure;

FIG. 8 is a flowchart illustrating a method of rendering a mixed reality environment based on light source data according to an embodiment of this disclosure;

FIGS. 9 and 10 are illustrations showing the method of FIG. 8 applied to a mixed reality environment according to an embodiment of this disclosure according to an embodiment of this disclosure;

FIG. 11 is a flowchart illustrating a method of rendering a mixed reality environment based on a reflective surface data according to an embodiment of this disclosure;

FIGS. 12 and 13 are illustrations showing the method of FIG. 11 applied to a mixed reality environment according to an embodiment of this disclosure according to an embodiment of this disclosure.

### DETAILED DESCRIPTION

Embodiments of this disclosure are described in the following with reference to the accompanying drawings.

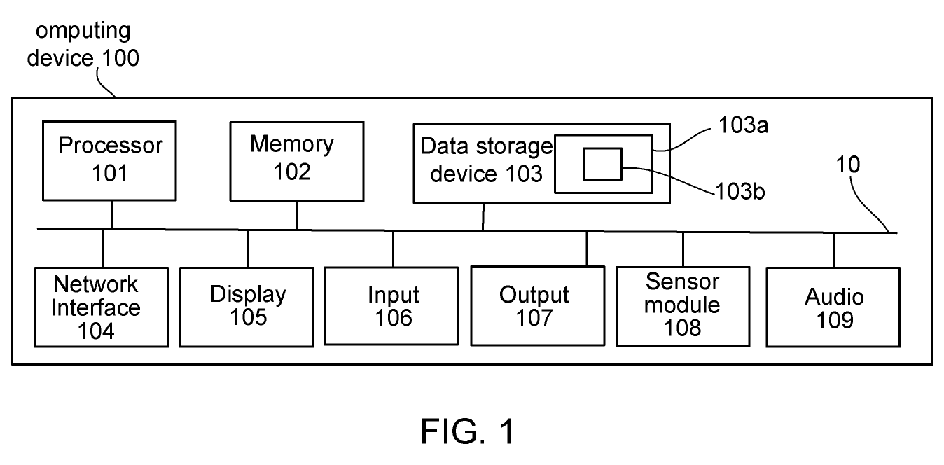

FIG. 1 illustrates a block diagram of one example implementation of a computing device 100. The computing device 100 may be any type of computing device, including but not limited to, an extended reality headset, a PC, laptop, tablet computer, mobile phone, television or smart TV, smart watch, and/or gaming console. The computing device 100 may comprise a plurality of electronic devices operably in communication with each other.

The computing device 100 is associated with executable instructions for causing the computing device 100 to perform any one or more of the methodologies discussed herein. In alternative implementations, the computing device 100 may be connected (e.g., networked) to other machines in a Local Area Network (LAN), an intranet, an extranet, or the Internet. The computing device 100 may operate in the capacity of a server or a client machine in a client-server network environment, or as a peer machine in a peer-to-peer (or distributed) network environment. The computing device 100 may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The computing device 100 includes a processing module 101, a memory module 102, and a secondary memory (e.g., a data storage device 103), which communicate with each other via a bus 10. The memory module may be read-only memory (ROM), flash memory, dynamic random-access memory (DRAM) such as synchronous DRAM (SDRAM) or Rambus DRAM (RDRAM), static random-access memory (SRAM), etc.

Processing module 101 represents one or more general-purpose processors such as a microprocessor, central processing unit, or the like. More particularly, the processing module 101 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing module 101 may also be one or more special-purpose processing modules such as an application specific integrated circuit (ASIC), a field programmable gate array (FPGA), a digital signal processor (DSP), network processor, or the like. Processing module 101 is configured to execute the processing logic (instructions 103b) for performing the operations and steps discussed herein.

The computing device 100 may further include a network interface module 104. The computing device 100 also may include a video display unit 105 (e.g., an organic light emitting diode display (OLED), a liquid crystal display (LCD) or a cathode ray tube (CRT)), and an audio device 109 (e.g., a speaker). The computing device 100 may further include a data input 106 and a data output 107 to receive and send data to and from the computing device 100.

The data storage device 103 may include one or more machine-readable storage media (or more specifically one or more non-transitory computer-readable storage media) 203a on which is stored one or more sets of instructions 103b embodying any one or more of the methodologies or functions described herein. The instructions 103b may also reside, completely or at least partially, within the memory module 102 and/or within the processing module 101 during execution thereof by the computing device 100, the memory module 102 and the processing module 101 also constituting computer-readable storage media.

The computing device 100 includes a sensor module 108 comprising one or more sensors such as six-axis motion sensor (three-axis gyroscope, three-axis accelerometer), infrared (IR) proximity sensor, one or more embedded cameras (including IR cameras), light sensor, etc.

The computing device 100 is not limited to the above arrangement. Other arrangements may be used. For example, the computing device 100 may be a distributed computing system.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components, and other features described herein can be implemented as discrete components or integrated in the functionality of hardware components such as ASICS, FPGAs, DSPs, or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “providing”, “calculating”, “computing,” “identifying”, “detecting ”, “establishing” , “training”, “determining”, “storing”, “generating” ,”checking”, “obtaining” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

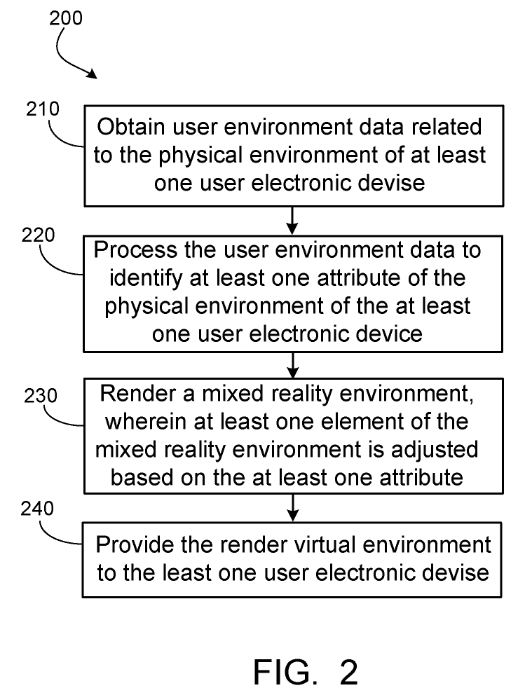

A method 200 of providing an extended reality environment according to an embodiment of this disclosure is illustrated in the flowchart in FIG. 2.

At step 210, the method 200 includes obtaining user environment data relating to the physical environment of at least one user electronic device.

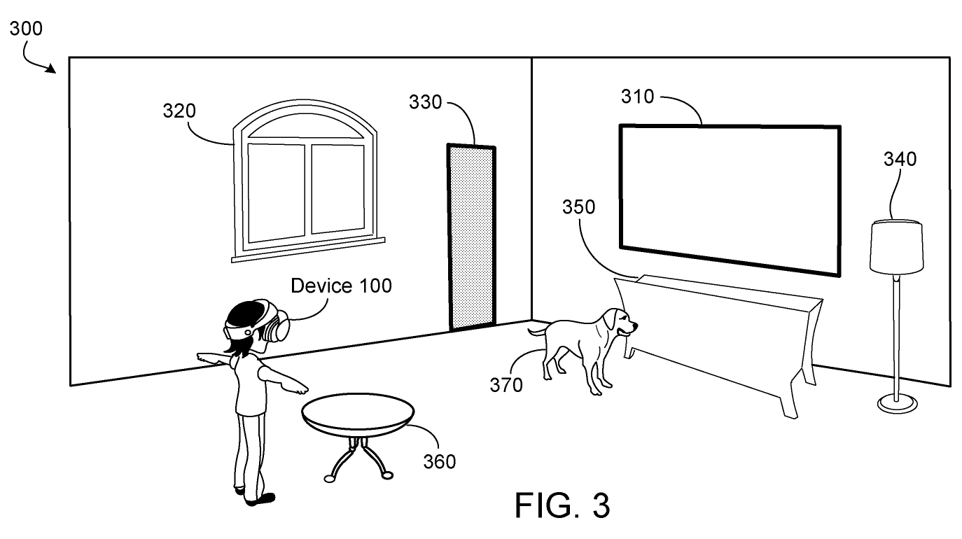

FIG. 3 shows a physical environment 300. In this case, the physical environment 300 is a living room comprising one or more static objects and dynamic objects. The static objects in the physical environment include a wall mounted display 310 (such as a TV or monitor), a window 320, a mirror 330, a floor lamp 340, a cabinet 350, and a table 360. The dynamic objects in the physical environment 300 include a dog (live animal) 370 which moves around the physical environment 300 on its own free will. The dog 370 is provided as an illustrative example of a physical object which may be present inside a physical environment.

FIG. 3 further shows a computing device 100 being used within the physical environment 300. In this embodiment, the computing device 100 is part of a user electronic device - an extended reality headset which is donned by a user. The extended reality headset will herein be referred to as the computing device 100 for simplicity, however, the computing device 100 is not limited to being an extended reality headset. As explained above, the computing device 100 may be any type of computing device, including but not limited to, a PC, laptop, tablet computer, mobile phone, television or smart TV, smart watch, and/or gaming console. Furthermore, the computing device 100 may comprise a plurality of user electronic devices operably in communication with each other.

The computing device 100, via the sensor module 108, captures and obtains user environment data relating to the physical environment of the computing device 100. The user environment data may be in the form of images captured or a video feed by cameras on the sensor module 108, IR images captures by IR cameras, positional information captured by proximity sensors, etc. The user environment data is not limited to the above data types, and any type of data may be obtained based on the types of sensors equipped on the sensor module 108.

In an alternative embodiment, the computing device 100 may be separate to a user electronic device. In this embodiment, a user electronic device may capture the user environment data using a sensor module and send the captured user environment data to the computing device 100 via a wired/wireless communication channel. In this embodiment, the computing device 100 may be within the same physical environment as the user electronic device, or it may be in a separate environment to the user electronic device. Furthermore, both the user electronic device and the computing device may be in the form of computing device 100 with all the modules of computing device 100, or the user electronic device may comprise some of the modules of computing device 100 (such as the sensor module 108) whilst the computing device may comprise other modules (such as the processing module 101). For example, the user electronic device may be an extended reality headset or a mobile phone within a physical environment such as physical environment 300. In this example, the user electronic device captures the user environment data which is then obtained by a computing device which may be a video game console or a PC within the physical environment. In another example, the computing device may be a server which is in a separate physical environment to the physical environment. In this example, the computing device obtains the user environment data from the user electronic device in the physical environment via a wireless communication channel. Furthermore, in this example, the computing device may provide a rendered extended reality environment to multiple user electronic devices in the same or in separate physical environments. The present specification is not limited to the arrangements as discussed in the above embodiments. Any arrangement may be used as long as user environment data relating to a physical environment is obtained by a computing device.

At step 220, the method 200 includes processing the user environment data to identify at least one attribute of the physical environment of the at least one user electronic device. Referring back to FIG. 3, once the computing device 100 obtains the user environment data, it processes the data, via the processing module 101, to identify at least one attribute of the physical environment of the computing device 100.

A first attribute is object data indicative of the static and/or dynamic object(s) in the physical environment 300. The object data comprises information such as the location of the object within the physical environment 300 and the dimensions of the object. The object data further comprises information such as the identity of the object (e.g. whether the object is a table or a TV) and the motion status of the object (e.g. whether the object is static or dynamic).

The object data is captured via the sensor module 108 of the computing device 100. For example, the location of the object can be captured using IR proximity sensors which indicate a distance of the object from the sensor. Furthermore, data captured from the camera(s) and/or IR camera(s) can be used to determine the shape and size of the object, and also whether the object is dynamic as the sensors are able to determine whether the object has moved from a first position to a second position within the physical environment.

In an embodiment, determining the location of objects within the physical environment comprises the use of Simultaneous Localisation and Mapping (SLAM) technology. In this embodiment, one or more sensors of the sensor module are used to build a map of the physical environment and subsequently determine a location of the computing device within the physical environment. In the process of building a map of the physical environment, the locations of static and/or dynamic objects within the physical location are also determined.

In an embodiment, the computing device uses an artificial neural network (ANN) to determine the identity of the object. In this embodiment, large datasets of images with labeled objects are used as training data for the ANN. The images may be preprocessed to enhance features or reduce noise. This may involve resizing, normalization, or other techniques to make the images more uniform for analysis. The ANN identifies distinctive features within the images (such as edges, corners, textures, or other patterns) that are useful for distinguishing one object from another and is trained on the labeled dataset. During training, the ANN learns to associate specific features with certain objects.

Once the ANN is trained, it can be used to detect and identify objects within new images captured by the sensor module 108. This comprises scanning the image at various scales and locations to identify regions that may contain objects. Once objects are detected, the ANN classifies them into predefined categories based on the features it has learned during training. This step involves assigning a label or category to each detected object. After classification, post-processing techniques may be applied to refine the results. This could involve filtering out false positives, improving the accuracy of object boundaries, or other optimizations. The final output includes a list of detected objects along with their corresponding labels and bounding boxes indicating their locations within the image. Alternatively, image segmentation techniques may be applied to the images captured by the sensor module 108 to identify objects within images.

The ANN may be part of the processing module 101 or may be implemented as a separate module within the computing device 100. In an embodiment, the ANN may be separate to the computing device 100 and may communicate with the computing device via a wireless communication channel. For example, the ANN may be part of a server in communication with the computing device 100.

Another attribute which may be captured by the sensor module 108 is lighting data indicative of lighting conditions within the physical environment. With reference to FIG. 3, the lighting data comprises ambient light levels indicative of the brightness of the physical environment 300. The lighting data also comprises light source data indicative of the sources of light within the physical environment 300 (e.g. artificial light sources such as lamps, and natural light sources from a window). Furthermore, the lighting data also comprises reflective surface data indicative of reflective surfaces (e.g. mirrors, or chrome objects) within the physical environment 300. The data may be captured using optical sensors or may be captured using a data feed indicating lighting conditions in the environment e.g. the data feed may indicate that no lighting is switched on the physical environment or the data feed may indicate that a lamp is switched on.

Just like the object data, the lighting data is captured via the sensor module 108 of the computing device 100. The ambient light levels, lighting data, and reflective surface data may be detected via the use of light level sensors such as a photo-diode type light level sensor and/or other sensors of the sensor module such as the cameras and IR cameras.

In an embodiment, an ANN may also be used in a similar way to the object recognition as described above to determine features related to light conditions. That is to say, the ANN may be trained to recognise a dark room or a light room. The ANN may be trained to identify lighting-related phenomena such as reflective surfaces or specific light sources such as daylight, light from a lamp etc.

The at least one attribute of the physical environment of the computing device 100 as determined by the processing module 101 is not limited to object data and lighting data. Other attributes may also be determined to assist with providing an enhanced user experience through the extended reality environment.

At step 230, the method 200 includes rendering a virtual environment, wherein at least one element of the virtual environment is adjusted based on the at least one attribute.

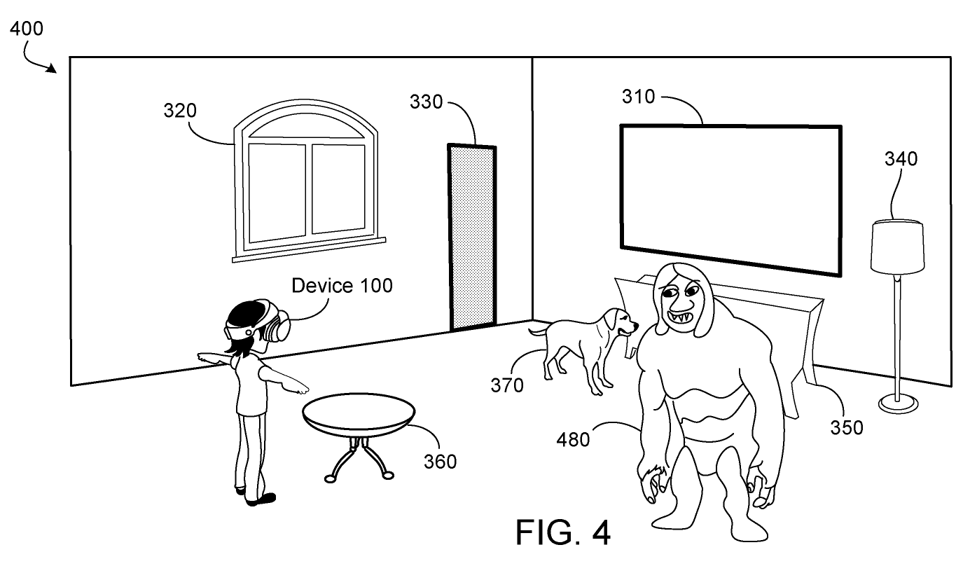

FIG. 4 shows an example mixed reality environment 400 which has been rendered based on the object data identified from processing the user environment data relating to the physical environment 300 of FIG. 3. The mixed reality environment 400 comprises a virtual element in a location relative to the static and dynamic objects in the physical environment 300. In this case, the mixed reality environment 400 comprises a non-playable character (NPC) 480 in a location relative to the static and dynamic objects within the physical environment 300.

The NPC 480 has been rendered based on the object data identified from processing the user environment data relating to the physical environment 300. More specifically, the location and dimension data of the dynamic and static objects in the physical environment 300 have been used to determine a size and position of the NPC 480 relative to the objects in the physical environment 300. The size and position of the NPC 480 have been determined such that the static and dynamic objects would not “clash” with the rendered NPC 480. That is to say, the rendered NPC is rendered in such a way that it does not appear in the same location as one of the static and dynamic objects.

In an embodiment, the location and dimensional data of the dynamic objects are continuously monitored in real time such that the virtual objects such as the NPC 480 can be rendered in such a way to avoid the dynamic objects in the physical environment 300. For example, the location and dimension of the dog 370 in the physical environment 300 may be monitored in real time via a camera and/or other sensors of the sensor module 108. In this example, if it is determined that the dog 370 in the physical environment 300 is walking towards the location of the NPC 480 in the mixed reality environment, a corrective action can be performed. For example, the NPC 480 may be rendered such that they walk to a different position within the mixed reality environment 400 to avoid the dog 370 and the other objects within the physical environment 300. Other actions may also be rendered such as the NPC 480 looking at the dog 370 as the dog 370 walks by the NPC 480.

In a further embodiment, the virtual elements may be rendered in the mixed reality environment in such a way that they interact with the physical objects that exist within the physical environment. For example, a virtual map may be rendered such that it appears to be placed on top of the table 360. In a further example, virtual elements may be rendered to interact with the dynamic elements in the physical environment. For instance, a virtual saddle may be rendered such that it appears on the dog 370 and continues to be on the dog 370 even as it moves through the physical environment 300.

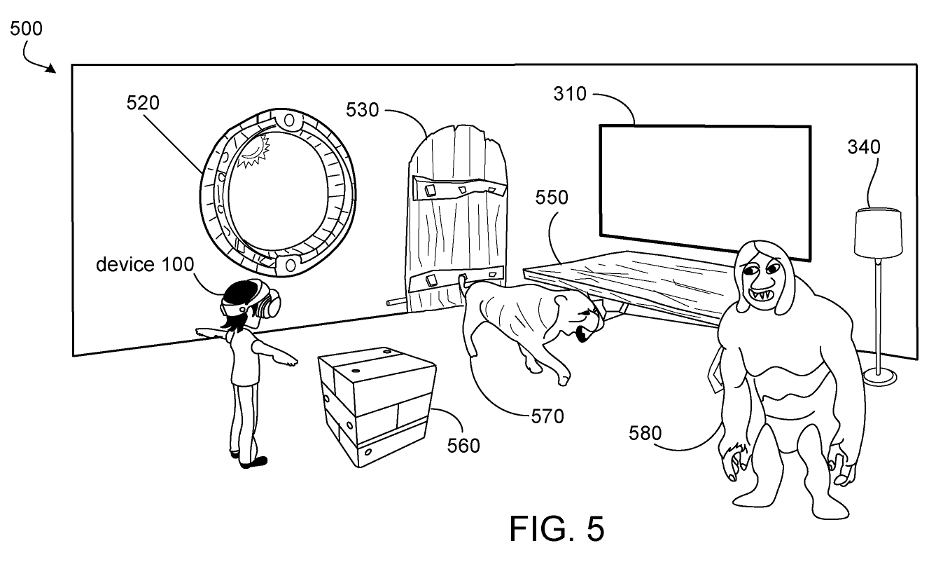

FIG. 5 shows an example mixed reality environment 500 which has been rendered based on the object data identified from processing the user environment data relating to the physical environment 300. The mixed reality environment 500 comprises virtual elements in locations relative to the static and dynamic objects in the physical environment 300. In this case, the virtual elements in the mixed reality environment 500 comprise a virtual window 520, a virtual door 530, a virtual table 550, a virtual box 560, a dynamic virtual sabretooth tiger 570, and an NPC 580.

The virtual elements 520, 530, 550, 560, 570 and 580 have been rendered based on the object data identified from processing the user environment data relating to the physical environment 300. More specifically, the identity, motion status, location and dimension data of the dynamic and static objects in the physical environment 300 have been used to determine corresponding virtual elements to take the place of the static and dynamic objects within the mixed reality environment 500. In FIG. 5, the virtual window 520, virtual door 530, virtual table 550, virtual box 560, and dynamic virtual sabretooth tiger 570 in the mixed reality environment 500 have taken the place of the window 320, mirror 330, cabinet 350, table 360 and dog 370 of the physical environment 300 respectively.

In an embodiment, the motion status is used to determine whether an object is static or dynamic. If the object is determined to be dynamic, the virtual object that takes its place in the virtual environment is also dynamic. In this embodiment, the virtual object moves in the same way as the dynamic object. For example, in the extended reality environment 500, the dynamic sabretooth tiger 570 moves in the same way as the dog 370 of the physical environment 300. That is to say, the movement of the virtual object may be synchronised with the movement of the dynamic object to which it corresponds in the physical environment. The orientation, colour, position and velocity of the virtual object may also be set to be equal to the corresponding values of the corresponding physical object. In an embodiment, the movement, orientation, colour, position and velocity of the virtual object may be set by user preferences of the user who dons the device 100. For example, the user preferences may comprise a setting that says that certain objects can be ignored. Another setting may say that animals, e.g. a dog, may appear as other animated forms such as, for example, a sabretooth tiger such as sabretooth tiger 570 or that animals would appear as the same animal but in a set colour, e.g purple or with larger eyes or other enhanced features. Generative artificial intelligence, such as a large language model, may be used to generate content which would be rendered in the augmented reality environment in the place of the physical object as described above.

In an embodiment, the virtual objects in FIG. 5 are determined using an ANN and object recognition. As explained above, the ANN is trained based on image and video data, and the identity of the objects in the physical environment 300 are determined. Once the identities of the objects are determined, the ANN refers to a virtual object database comprising a collection of objects and a corresponding virtual object from the database is selected to best match the static or dynamic object in the physical environment. In this embodiment, with reference to FIG. 5, the ANN identifies the window 320, mirror 330, cabinet 350, table 360 and dog 370 of the physical environment 300, and then renders the mixed reality environment 500 with the virtual window 520, virtual door 530, virtual table 550, virtual box 560, and dynamic virtual sabretooth tiger 570 in place of the corresponding objects in the physical environment 300. The ANN may use other information to determine which virtual objects are best suited to take the place of the physical objects. Such information may include a genre of content provided to the user via the mixed reality environment.

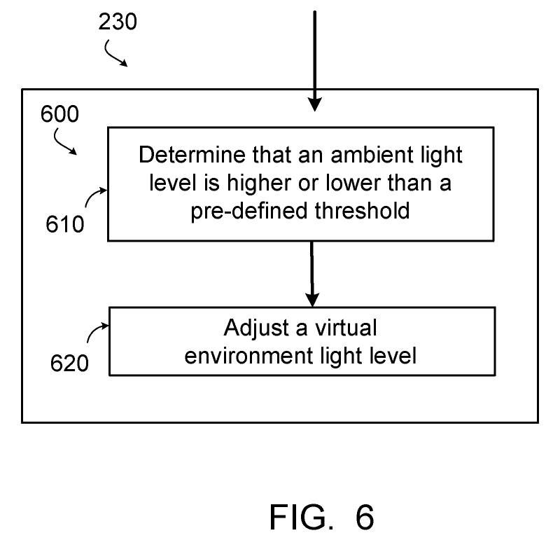

FIGS. 6, 9, and 11 provide methods 600, 900, and 1100 of rendering a mixed reality environment in accordance with step 230 of method 200. In these methods, the at least one element of the mixed reality environment is adjusted based on lighting data identified from processing the user environment data. The methods of FIGS. 6, 9, and 11 may be used individually, or in combination as part of the rendering of the mixed reality environment.

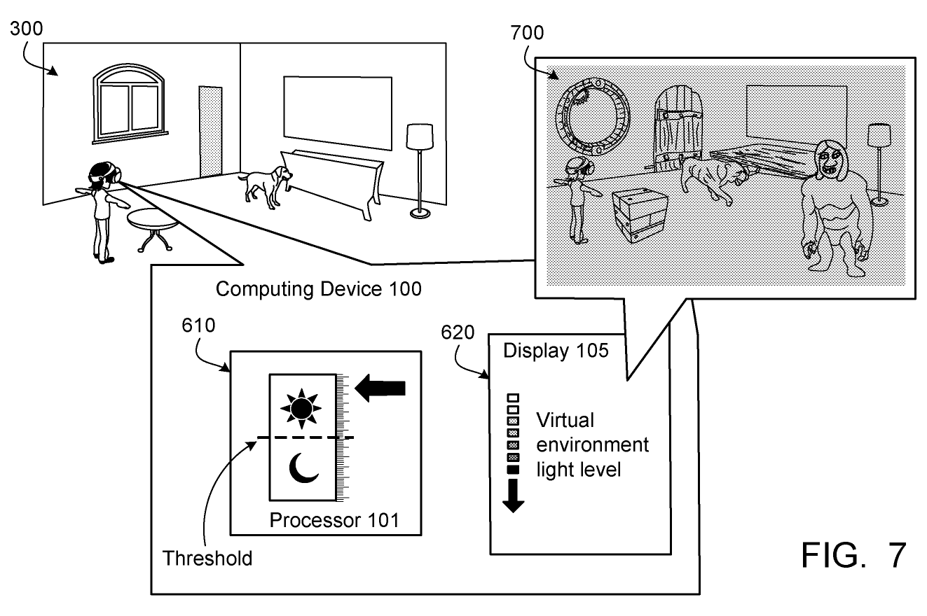

A method 600 of rendering a mixed reality environment based on lighting data in accordance with step 230 of method 200 is illustrated in the flowchart in FIG. 6. Further reference is made to FIG. 7 which shows the method 600 applied to a mixed reality environment 700.

At step 610, the method 600 includes determining that an ambient light level is higher or lower than a pre-defined threshold. The sensor module 108 captures the lighting data including ambient light level indicative of the brightness of the physical environment 300. The processing module 101 then obtains the lighting data and based on the ambient light level determines whether the brightness of the physical environment 300 is above or below a pre-determined threshold brightness. The threshold brightness can be set by the user of the computing device 100 based on their preferences, or it can be a default threshold level. In an embodiment, the threshold level is determined via the use of an ANN which analyses the lighting conditions within the physical environment and determines an optimum threshold level. The optimum threshold level may be determined based on the lighting conditions which make the virtual and/or physical objects clearly visible in the mixed reality environment. In FIG. 7, the processing module 101 determines that the ambient light level of the physical environment 300 has exceeded the threshold level.

At step 620, the method 600 includes adjusting a virtual environment light level. In response to determining whether the ambient light level of the physical environment 300 is above or below the pre-determined threshold, the processing module 101 adjusts a virtual environment light level. The virtual environment light level includes a plurality of picture correction settings including sharpness/softness, brightness/contrast, colour saturation and tone. The virtual environment light level is not limited to the above correction settings. Any number of correction settings may be used in order to adjust the virtual environment lighting level to optimise the viewing experience. In FIG. 7, in response to determining that the ambient light level has exceeded the threshold, the mixed reality environment 700 is rendered such that the brightness of the living room and the virtual objects are lowered.

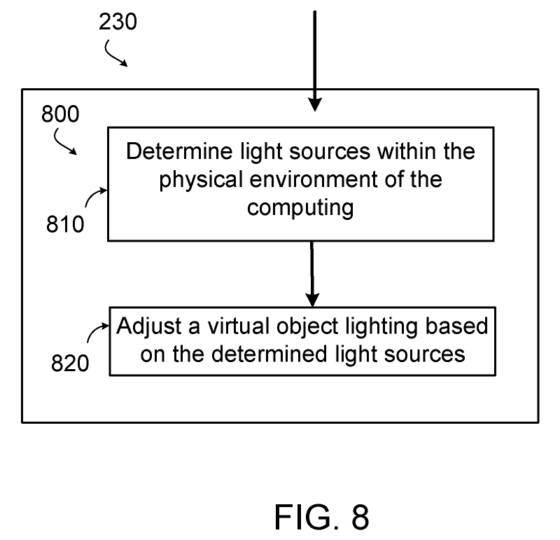

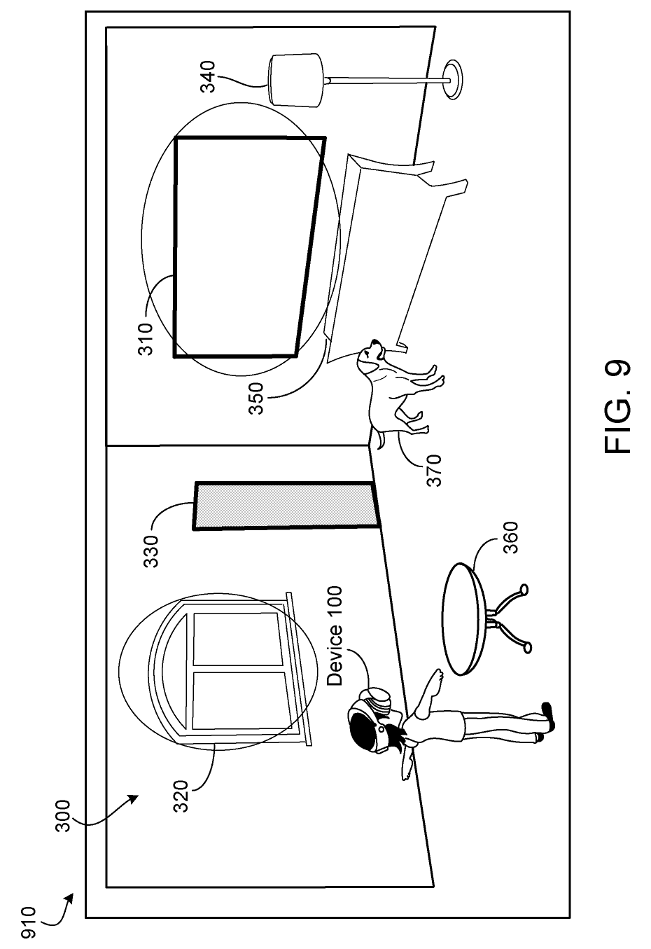

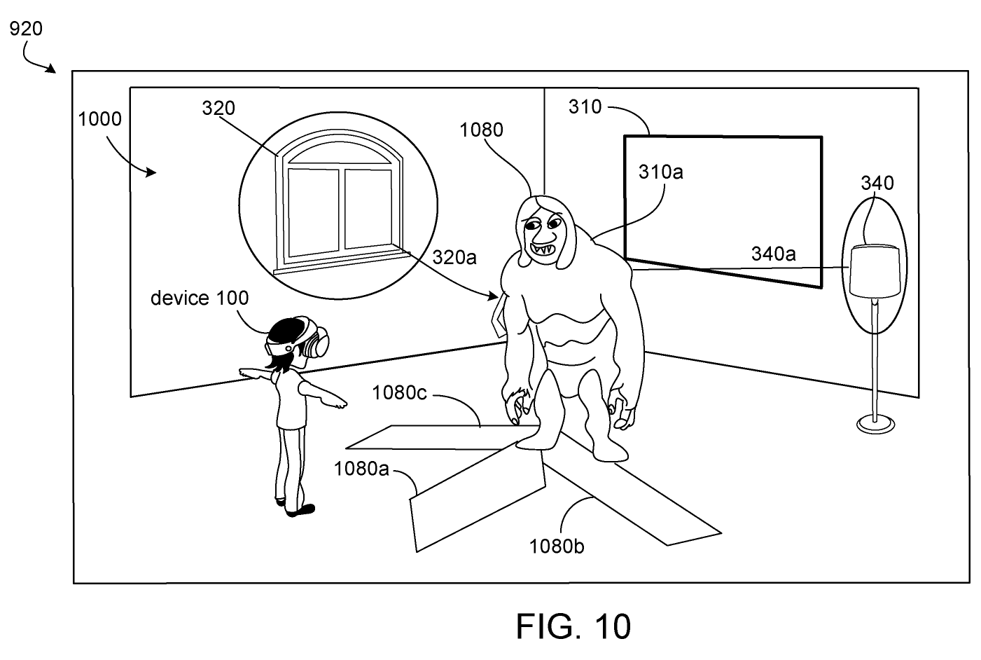

A method 800 of rendering a mixed reality environment based on lighting data in accordance with step 230 of method 200 is illustrated in the flowchart in FIG. 8. Further reference is made to FIGS. 9 and 10 which show the method 800 applied to a mixed reality environment 1000.

At step 810, the method 800 includes determining light sources within the physical environment of the computing device. The sensor module 108 captures the lighting data including light source data indicative of the sources of light within the physical environment 300. The processing module 101 then obtains the lighting data and based on the light source data determines the sources of light within the physical environment 300. In FIG. 9, the processing module 101 determines that the sources of light within the physical environment 300 are the wall mounted display 310, the window 320, and the floor lamp 340.

At step 820, the method 800 includes adjusting a virtual object lighting based on the determined light sources. In response to determining the light sources within the physical environment 300, the processing module 101 adjusts a virtual object lighting. The virtual object lighting includes the lighting and shadows of the virtual object itself. In FIG. 10, in response to determining the light sources within the physical environment 300, the mixed reality environment 1000 is rendered such that a virtual object, in this case an NPC 1080, casts shadow 1080a based on the light 310a produced from the wall mounted display 310, shadow 1080b based on the light 320a produced from the window 320, and shadow 1080c based on the light 340a produced from the floor lamp 340.

In addition to the shadows cast due to the light source, the virtual objects in the mixed reality environment may be illuminated based on the light sources. For example, the NPC 1080 may be rendered in such a way that it is brighter on the sides facing the sources of light. Furthermore, the rendering process may utilise ray tracing which determines the way light from light sources get reflected within the mixed reality environment. For example, if ray tracing were to be utilised when rendering the mixed reality environment 1000, the light 320a from the window 320 may further reflect off the NPC 1080 and illuminate other areas of the room accordingly.

In an embodiment, as part of determining the light sources within the physical environment, the illuminance of the light sources is also determined. For example, referring to FIGS. 9 and 10, the illuminance of the light 320a from the window 320 may be determined to estimate the time of day in the real world. In this example, if it is determined that the illuminance is high – which corresponds to daytime – then the rendering process may also comprise providing virtual objects which best reflect the time of day. For instance, a virtual window may be rendered with a view depicting daytime out of the window to replace the window 320. Similarly, a warmer lighting may be used to render the mixed reality environment compared to a cooler lighting if it were determined to be nighttime in the real world.

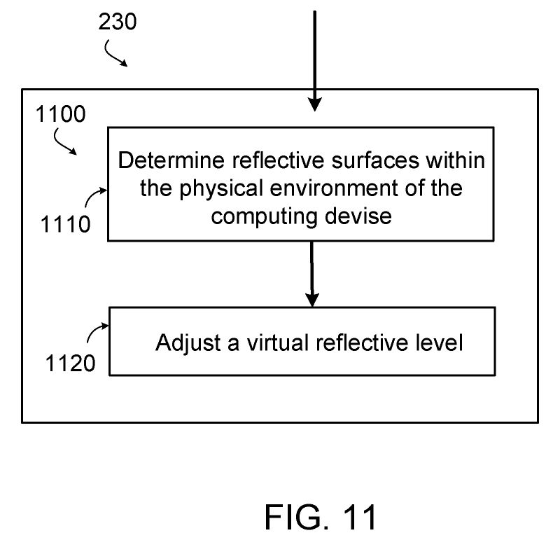

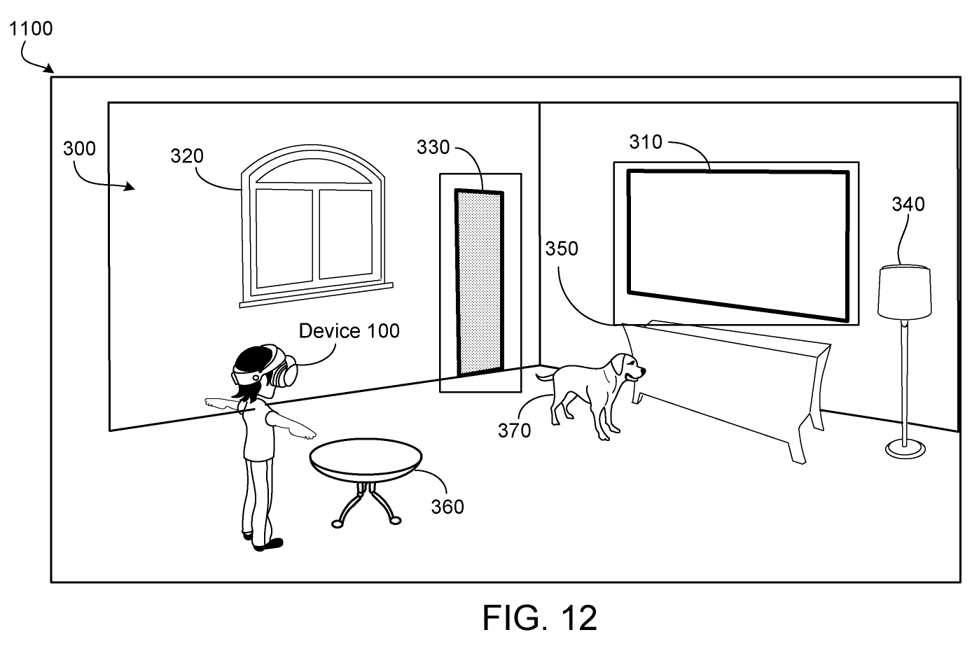

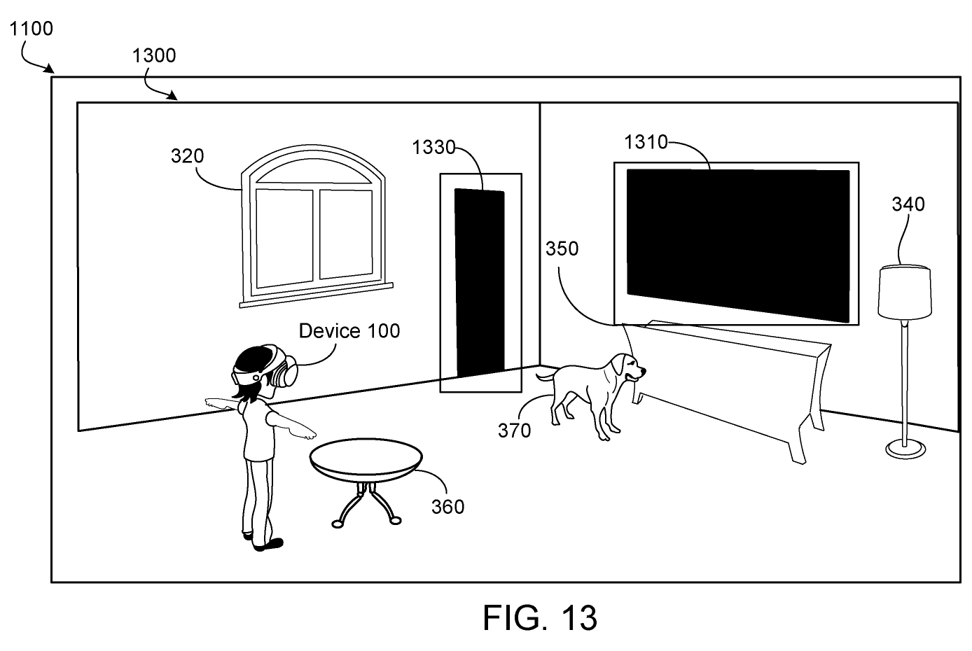

A method 1100 of rendering a mixed reality environment based on lighting data in accordance with step 230 of method 200 is illustrated in the flowchart in FIG. 11. Further reference is made to FIGS. 12 and 13 which show the method 1100 applied to a mixed reality environment 1300.

At step 1110, the method 1100 includes determining reflective surfaces within the physical environment of the computing device. The sensor module 108 captures the lighting data including reflective surface data indicative of reflective surfaces within the physical environment 300. The processing module 101 then obtains the lighting data and based on the reflective surface data determines the objects within the physical environment 300 which have reflective surfaces. In FIG. 12, the processing module 101 determines that the objects within the physical environment 300 with reflective surfaces are the mirror 330 and the wall mounted display 310.

At step 1120, the method 1100 includes adjusting a virtual object reflectivity level based on the determined reflective surfaces. In response to determining the objects within the physical environment 300 with reflective surfaces, the processing module 101 adjusts a virtual object reflectivity level. The virtual object reflectivity level includes how reflective the surface of the reflective object is. In FIG. 13, in response to determining the reflective objects within the physical environment 300, the mixed reality environment 1300 is rendered such that the reflectivity of the mirror 330 and the wall mounted display 310 are reduced. In this case the reflectivity of both the mirror 330 and the wall mounted display 310 have been brought down to zero – no reflections. As such, the reflective surface of the mirror 330 and the wall mounted display 310 is just a black square. In other implementations however, the reflectivity of the reflective surface of the reflective virtual object in the mixed reality environment may be rendered so that it is blurry compared to the reflectivity of the object in the physical environment.

In an embodiment, the user of the user electronic device is provided a prompt to select which objects they would like to have rendered in the extended reality environment. The user may be shown identified physical objects within the physical environment and identified light sources and the user can pick and choose which virtual objects are rendered. Furthermore, the user may also be provided with an option to choose the lighting they want in the rendered extended reality environment. For example, the user may be shown a slider to adjust the brightness and/or other picture correction settings according to their preference.

At step 240, the method 200 includes providing the rendered mixed realty environment to the at least one user electronic device. Once the mixed realty environment has been rendered as mentioned above, it is sent to the user electronic device. In the embodiments shown in FIGS. 3, 4, 5, 7, 9, 10, 12 and 13, the user electronic device is the computing device 100. As such, the computing device 100 provides the mixed reality environment by displaying it on the display 105. However, as mentioned above, the computing device 100 is not limited to being part of the user electronic device. Therefore, in other embodiments, where the user electronic device is separate to the computing device, the rendered mixed reality environment is provided to the user electronic device via a wired/wireless communication network and displayed to the user via a display on the user electronic device.

Accordingly, there has been described a method of providing an extended reality environment, the method comprising obtaining user environment data relating to the physical environment of a user electronic device, processing the user environment data to identify at least one attribute of the physical environment of a user electronic device, rendering a mixed reality environment, wherein at least one element of the mixed reality environment is adjusted based on the at least one attribute, and providing the rendered mixed environment to the user electronic device.

Although particular embodiments of this disclosure have been described, many modifications/additions and/or substitutions may be made within the scope of the claims.

It should be noted that the above-mentioned aspects and embodiments illustrate rather than limit the disclosure, and that those skilled in the art will be capable of designing many alternative embodiments without departing from the scope of the disclosure as defined by the appended claims. In the claims, any reference signs placed in parentheses shall not be construed as limiting the claims. The word "comprising" and "comprises", and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The disclosure may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A computer implemented method of providing an extended reality environment, the method comprising:
obtaining, via a computing device, user environment data relating to the physical environment of at least one user electronic device;
processing the user environment data to identify at least one attribute of the physical environment of the at least one user electronic device;
rendering an extended reality environment, wherein at least one element of the mixed reality environment is adjusted based on the at least one attribute; and
providing the rendered extended reality environment to the at least one user electronic device.

2. The method of claim 1, wherein the computing device is part of the at least one user electronic device.

3. The method of claim 1, wherein the at least one attribute comprises object data indicative of static and/or dynamic objects within the physical environment of the user electronic device.

4. The method of claim 3, wherein rendering the extended reality environment comprises rendering a virtual object in a virtual location relative to a physical location of the static and/or dynamic objects within the physical environment of the user electronic device.

5. The method of claim 4, wherein the physical location of the dynamic objects within the physical environment of the user electronic device is continuously tracked.

6. The method of claim 3, wherein rendering the extended reality environment further comprises converting the static and/or dynamic objects into static and/or dynamic virtual objects.

7. The method of claim 6, wherein converting the static or dynamic objects into static or dynamic virtual objects comprises:
identifying the static and/or dynamic objects, the identifying utilising a machine learning model trained using input image data of physical objects; and
matching the identified static and/or dynamic objects with corresponding static and/or dynamic virtual objects in a virtual object database.

8. The method of claim 1, wherein the at least one attribute comprises lighting data indicative of lighting conditions within the physical environment of the user electronic device.

9. The method of claim 8, wherein the lighting data comprises an ambient light level.

10. The method of claim 9, wherein rendering the extended reality environment comprises determining that the ambient light level is higher or lower than a pre-defined threshold and adjusting a virtual environment light level.

11. The method of claim 8, wherein the lighting data comprises light source data indicative of sources of light within the physical environment of the user electronic device.

12. The method of claim 9, wherein rendering the extended reality environment comprises adjusting a virtual object lighting based on the determined sources of light.

13. The method of claim 8, wherein the light source data comprises reflective surface data indicative of reflective surfaces within the physical environment of the user electronic device.

14. The method of claim 13, wherein rendering the extended reality environment comprises adjusting a virtual reflectivity level.

15. A system comprising:
one or more computer processors; and
one or more non-transitory computer-readable media that store instructions which, when executed by the one or more computer processors, cause the one or more computer processors to perform operations comprising:
obtaining user environment data relating to the physical environment of at least one user electronic device;
processing the user environment data to identify at least one attribute of the physical environment of the at least one user electronic device;
rendering an extended reality environment, wherein at least one element of the mixed reality environment is adjusted based on the at least one attribute; and
providing the rendered extended reality environment to the at least one user electronic device.

16. The system of claim 15, wherein the computing device is part of the at least one user electronic device.

17. The system of claim 15, wherein the at least one attribute comprises object data indicative of static and/or dynamic objects within the physical environment of the user electronic device.

18. The system of claim 7, wherein rendering the extended reality environment comprises rendering a virtual object in a virtual location relative to a physical location of the static and/or dynamic objects within the physical environment of the user electronic device.

19. One or more non-transitory computer-readable media that store instructions which, when executed by one or more computer processors, cause the one or more computer processors to perform operations comprising:
obtaining user environment data relating to the physical environment of at least one user electronic device;
processing the user environment data to identify at least one attribute of the physical environment of the at least one user electronic device;
rendering an extended reality environment, wherein at least one element of the mixed reality environment is adjusted based on the at least one attribute; and
providing the rendered extended reality environment to the at least one user electronic device.

20. The media of claim 19, wherein the computing device is part of the at least one user electronic device.
